(19) United States
(12) Patent Application Publication
(10) Pub. No.: US 2009/0274485 A1
(43) Pub. Date: Nov. 5, 2009

(54) Development device comprising process cartridge and image formation apparatus comprising development device

(76) Inventors: Tomoya Adachi, Amagasaki-shi (JP); Yoshiko Ogawa, Osaka (JP)

Correspondence Address: HARNESS, DICKEY & PIERCE, P.L.C., P.O. BOX 8910, RESTON, VA, 20195, US

(21) Appl. No.: 12/379,837

(22) Filed: Mar. 3, 2009

(30) Foreign Application Priority Data
Mar. 3, 2008 (JP) 2008-051542

(51) Int. Cl. G03G 15/08

(52) U.S. Cl. 399/119

(57) ABSTRACT

A process cartridge capable of lowering the line pressure of an abutment section of a layer thickness regulating member and thus reducing the stress on toner when the toner passes the abutment section. Toner adhering to the surface of a supply roller is supplied and applied to the surface of a development roller. The development roller is a roller covered with an elastic rubber layer and the elastic rubber layer is set to have a hardness which makes it possible to prevent toner degradation caused by a concentration of pressure exerted on an abutment section which abuts against a layer thickness regulating member. The surface roughness Ra is set at 0.3 to 2.0 μm, whereby the required amount of toner can be held by the surface. The resistance value of the elastic rubber layer is set at 10³ to 10¹⁰Ω in consideration of the application of a development bias. The layer thickness regulating member is fixed to a development device in a state where the top of the layer thickness regulating member is inserted into the development device. A thin plate made of metal mainly such as SUS or phosphor bronze, or a thin plate subjected to bending process is employed as the layer thickness regulating member.

### BACKGROUND OF THE INVENTION

1. Field of the Invention

The present invention relates to an image formation apparatus such as a photocopier, a facsimile device, or a printer which executes an electrophotographic process, and more particularly, to a process cartridge that is used in a development device of the image formation apparatus and to a development device which uses the process cartridge.

2. Description of the Related Art

When a nonmagnetic one-component developer and a regulating member in particular are employed in a development device of an image formation apparatus of this type, it is essential not only that the stress on the toner be reduced as much as possible but also that an appropriate amount of transportation of toner be established and that the toner be adequately electrified.

For example, Japanese Patent Application Laid Open No. H11-1526 (called ‘Prior Art 1’ hereinbelow) discloses a technology whereby performing mirror-surface processing on a slide contact section of a regulating member which makes slide contact between the regulating member and a development roller suppresses deterioration of toner, scraping of the surface of the development roller and scraping of the surface of the regulating member, and whereby affording sections which do not make slide contact a greater roughness than the slide contact section generates frictional electrification of the non-slide contact sections which is then regulated by the slide contact section, thereby generating adequate frictional electrification of the toner.

Furthermore, Japanese Patent Application Laid Open No. 2006-209010 (called ‘Prior Art 2’ hereinbelow) discloses a technology for sensing when it is time to exchange toner by constituting an abutment section of the regulating member via which the regulating member abuts against the development roller by a first layer constituted to frictionally electrify the toner and a second layer which is covered by the first layer and constituted to generate inferior electrification of the toner upon exposure of the second layer as a result of the first layer being worn and scraped off by the rotation of the development roller.

In addition, Japanese Patent Application Laid Open No. 2005-37775 (called ‘Prior Art 3’ hereinbelow) discloses technology for preventing fusion between a regulating member and toner and maintaining electrification performance by constituting a regulating member by laminating a second layer which employs a material exhibiting little adhesion to toner on a first layer which employs a material exhibiting a high frictional electrification performance.

Furthermore, Japanese Patent Application Laid Open H3-166567 (called ‘Prior Art 4’ hereinbelow) discloses technology for enhancing a toner electrification characteristic and properties for release from the toner by providing a regulating member with a resin layer which contains a surfactant and has a film thickness of 10 μm or less on a conductive substrate and by providing means for applying a bias for the desired electrification properties.

The technology of Prior Art 4 controls electrification properties not only through frictional electrification by applying a bias to the regulating member but also through charge injection in which charge is imparted to the toner. The technology of Prior Art 1 performs mirror surface processing on the surface of the abutment section which abuts against the development roller and makes the surface roughness of sections which do not abut against the development roller and are close to the abutment section large in order to prevent scraping of the surface of the development roller and of the surface of the regulating member by the abutment section and also provide electrification properties.

However, when the surface of the abutment section is afforded an excessively small surface roughness as is the case with mirror surface processing, there is then the problem that the force for regulating the amount of toner transportation is small and, in a low temperature and low humidity environment in particular, that the electrostatic adhesion between the development roller and toner is large and the amount of toner transportation increases.

Therefore, although a method which increases the force for regulating the amount of transportation by raising the regulating force may be considered, this method generates another problem that the stress on the toner is large when the toner is passing the regulating portion and the toner deteriorates due to breakdown of the toner and due to the peeling and embedding of an external additive, thereby causing the image quality to worsen over time and toner to become fixed in the vicinity of the abutment section. That is, the provision of an appropriate amount of toner transportation over time together with adequate electrification properties cannot be achieved in addition to suppressing toner deterioration.

According to the technologies of Prior Art 2 and Prior Art 3, the abutment section of the regulating member which abuts against the development roller is constituted by two layers. The former technology is utilized for the purpose of toner sensing by laminating an electrifying material on a material which generates inferior electrification and by the characteristics being changed over time due to wear. The latter technology prevents the fixation of toner and also secures electrification properties by laminating a material exhibiting little adhesion to toner on a material which exhibits a high frictional electrification performance.

However, with the former technology, pre-endurance toner with high chargeability as is initially the case is overcharged and, in a low temperature and low humidity environment in particular, highly charged toner which has been overcharged is not refreshed by the development roller and induces filming. Consequently, the amount of transportation increases. Furthermore, with the latter technology, because another material is laminated on a material which exhibits a high frictional electrification performance, there is no friction between the material of the lower layer and the actual toner, and therefore frictional electrification is dependent on the material of the upper layer and adequate electrification properties cannot be secured.

Technologies relating to the present invention are also disclosed in Japanese Patent No. 4,035,205, for example.

### SUMMARY OF THE INVENTION

It is an object of the present invention to provide, in a development device of an image formation apparatus, a regulating member which, in addition to suppressing the degradation of toner, is capable of establishing an appropriate amount of toner transportation with respect to environmental changes and deterioration with age and of having adequate electrification properties.

In an aspect of the present invention, a process cartridge comprises a developer carrier which employs a nonmagnetic one-component developer and which is provided rotatably in the vicinity of or in contact with a latent image carrier; a developer supply member which is provided rotatably so as to supply powdered developer onto the developer carrier; and a layer thickness regulating member which reduces a layer thickness of the developer on the developer carrier by abutting against the developer carrier. The layer thickness regulating member makes slide contact on its surface with the developer carrier and develops an electrostatic latent image on the latent image carrier by applying a predetermined voltage to the developer carrier. The layer thickness regulating member has a roughness on a slide contact section thereof which makes slide contact with the developer carrier, and is configured so that the roughness of a part of the layer thickness regulating member which protrudes upstream in a developer transportation direction is greater than the roughness of the slide contact section.

In another aspect of the present invention, a development device has a process cartridge and the process cartridge comprises a developer carrier which employs a nonmagnetic one-component developer and which is provided rotatably in the vicinity of or in contact with a latent image carrier; a developer supply member which is provided rotatably so as to supply powdered developer onto the developer carrier; and a layer thickness regulating member which reduces a layer thickness of the developer on the developer carrier by abutting against the developer carrier. The layer thickness regulating member makes slide contact on its surface with the developer carrier and develops an electrostatic latent image on the latent image carrier by applying a predetermined voltage to the developer carrier. The layer thickness regulating member has a roughness on a slide contact section thereof which makes slide contact with the developer carrier, and is configured so that the roughness of a part of the layer thickness regulating member which protrudes upstream in a developer transportation direction is greater than the roughness of the slide contact section.

In another aspect of the present invention, an image formation apparatus uses a development device having a process cartridge. The process cartridge comprises a developer carrier which employs a nonmagnetic one-component developer and which is provided rotatably in the vicinity of or in contact with a latent image carrier; a developer supply member which is provided rotatably so as to supply powdered developer onto the developer carrier; and a layer thickness regulating member which reduces a layer thickness of the developer on the developer carrier by abutting against the developer carrier. The layer thickness regulating member makes slide contact on its surface with the developer carrier and develops an electrostatic latent image on the latent image carrier by applying a predetermined voltage to the developer carrier. The layer thickness regulating member has a roughness on a slide contact section thereof which makes slide contact with the developer carrier, and is configured so that the roughness of a part of the layer thickness regulating member which protrudes upstream in a developer transportation direction is greater than the roughness of the slide contact section.

### BRIEF DESCRIPTION OF THE DRAWINGS

The above and other objects, features and advantages of the present invention will become more apparent from the following detailed description taken with the accompanying drawings in which:

FIG. 1 is a cross-sectional view of the constitution of the essential parts of an image formation apparatus which comprises a development device and a process cartridge unit according to the present invention;

FIG. 2 is a cross-sectional view of the constitution of the development device which the image formation apparatus in FIG. 1 comprises;

FIG. 3 is a cross-sectional view of the constitution of a layer thickness regulating member which the development device in FIG. 2 comprises;

FIGS. 4 and 5 serve to illustrate a layer thickness-regulating mechanism;

FIG. 6 shows the results of an experiment in which the surface roughness of an abutment section of the layer thickness regulating member is varied;

FIG. 7 is a cross-sectional view of another example of the constitution of the layer thickness regulating member; and

FIG. 8 is a perspective view of the constitution of sheet material.

### DESCRIPTION OF THE PREFERRED EMBODIMENT(s)

Each of the embodiments of the present invention will be described hereinbelow with reference to the drawings.

### First Embodiment

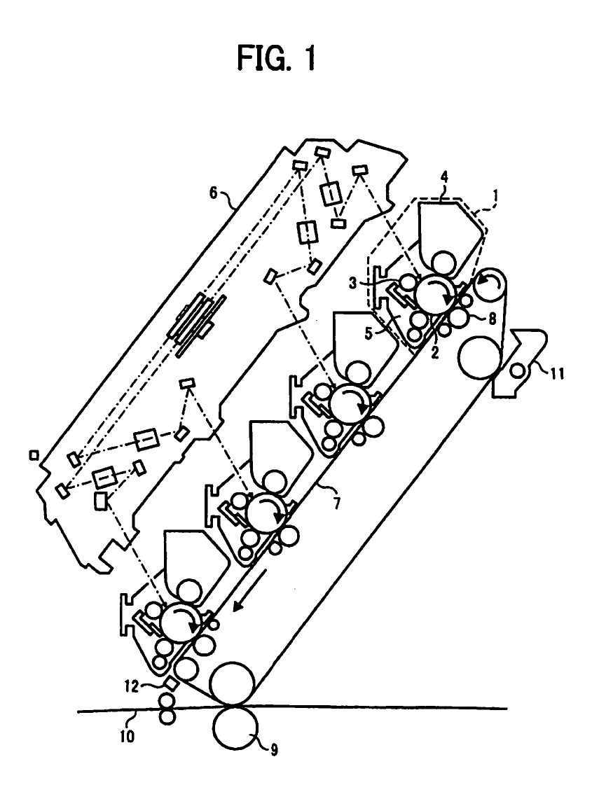

FIG. 1 shows the constitution of the essential parts of an image formation apparatus which comprises a development device and a process cartridge unit according to this embodiment. Each process cartridge unit 1 is constituted by integrally linking a photoreceptor drum 2, an electrification roller 3, development means 4, and cleaning means 5. The constitution is also such that each of the process cartridge units 1 can be exchanged by releasing the respective stoppers thereof.

The photoreceptor drum 2 rotates at a circumferential speed of 150 mm/sec in the direction of the arrow. The electrification roller 3 is pressure-welded to the surface of the photoreceptor drum 2 and is drive-rotated by the rotation of the photoreceptor drum 2. A predetermined bias is applied by a high-voltage power source (not shown) to the electrification roller 3 and the surface of the photoreceptor drum 2 is electrified to −500 V. Light exposure means 6 performs photographic exposure of image information on the photoreceptor drum 2 and forms an electrostatic latent image. A laser beam scanner which uses a laser diode or an LED and the like is used as the light exposure means 6. The development means 4 is nonmagnetic one-component contact development means which visualizes an electrostatic latent image on the photoreceptor drum 2 as a toner image. A predetermined development bias is supplied to the development means 4 by a high-voltage power source (not shown). The photoreceptor cleaning means 5 performs cleaning of residual toner after transfer on the surface of the photoreceptor drum 2.

Four individual process cartridge units 1 are provided in parallel in the direction of motion of an intermediate transfer belt 7 and form visible images in the order black, yellow, magenta and cyan. A primary transcription bias is applied to a primary transcription roller 8 and a toner image on the surface of the photoreceptor drum 2 is transferred to the surface of the intermediate transfer belt 7. The intermediate transfer belt 7 is rotationally driven in the direction of the arrow in FIG. 1 by a drive motor (not shown) and a full-color image is formed by sequentially transferring the visible images of each color to the surface so that the images are overlaid on one another.

The full color image thus formed is transferred to paper 10 which is transfer material by applying a predetermined current to a secondary transcription roller 9 by means of a high voltage power source (not shown) and is fixed by means of a fixing device (not shown) and then output. The toner which has not been transferred by the secondary transcription roller 9 and remains on the intermediate transfer belt 7 is recovered by transfer belt cleaning means 11.

The development operation of a developer which is denoted by reference numeral 4 in FIG. 1 will now be described.

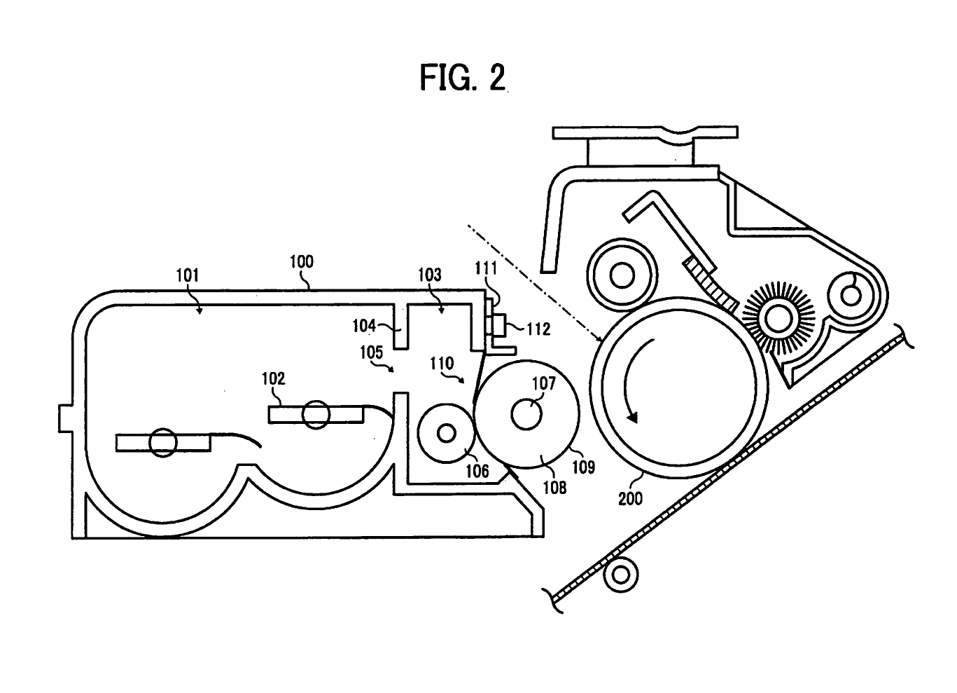

In the development device 100 shown in FIG. 2, a toner transport member 102 provided in the toner housing 101 rotates in a counterclockwise direction and delivers the housed toner in the direction of a toner supply chamber 103. An opening 105 is provided in a dividing wall 104 between the toner housing 101 and the toner supply chamber 103 and toner is moved via the opening 105 to the toner supply chamber 103 by means of the operation of the toner transportation member 102. The supply roller 106 provided in the toner supply chamber 103 is disposed so as to abut against the development roller 107.

A foaming material which has a structure comprising air holes (cells) covers the surface of the supply roller 106, secures a degree of toner adhesion to the supply roller 106, and prevents degradation of toner which is caused by a concentration of pressure exerted on the abutment section of the supply roller 106 against the development roller 107. Furthermore, a conductive foaming material containing carbon fine particles is used as the foaming material and an electrical resistance value of the supply roller 106 is set at 103 to 1012Ω. A supply bias of a value obtained by offsetting the development bias in the same direction as the electrification polarity of the toner is applied to the supply roller 106. The supply bias acts in the direction in which the pre-electrified toner is pushed against the development roller 107 by the abutment section which abuts against the development roller 107.

The supply roller 106 rotates in a clockwise direction and supplies and applies toner which has adhered to the surface thereof to the surface of the development roller 107. A roller covered with an elastic rubber layer 108 is employed as the development roller 107 and a surface coating layer 109 of a material which is easily electrified to the opposite polarity from that of the toner is provided on the surface of the roller. The elastic rubber layer 108 is set at a JIS A hardness of 60 or less in order to prevent toner deterioration caused by a concentration of pressure exerted on the abutment section against a layer thickness regulating member 110. The surface roughness Ra and is set at 0.3 to 2.0 μm, whereby the required amount of toner is held by the surface.

Furthermore, a development bias is applied to the development roller 107 in order to form an electrical field between the development roller 107 and a photoreceptor 200 and therefore the resistance value of an elastic rubber layer is set at 10³ to 10¹⁰Ω. The development roller 107 rotates in a clockwise direction and transports toner held by the surface of the development roller 107 to a position opposite the layer thickness regulating member 110 and the photoreceptor 200. The layer thickness regulating member 110 is fixed by a screw to the development device 100 by a holding member 111 and a screw 112 in a state where the top of the layer thickness regulating member 110 is inserted into the development device 100. A thin plate made of metal mainly such as SUS or phosphor bronze, or a thin plate subjected to bending process is employed as the layer thickness regulating member 110. A part made by pasting a urethane- or acrylic-based resin to the thin plate is sometimes also employed.

In this embodiment, screw fastening is taken as an example of the process of fixing the developer 100 and the layer thickness regulating member 110 but the fixing may also be achieved using laser welding. The free end of the layer thickness regulating member 110 is made to abut against the surface of the development roller 107 under a pressing force of 10 to 60 N/m and the toner thus subjected to this pressing force is thinned and charge is imparted to the toner by the frictional electrification.

Although the development roller 107 and photoreceptor 200 appear in contact with one another in FIG. 2, they may also be arranged out of contact. Furthermore, the photoreceptor 200 appears with a drum-like form but may also have a belt-like form.

Thereafter, in cases where, prior to forming images corresponding to a copy request made by the user, it is judged that there has been an environmental change or the developer has been used for a predetermined number of copies or more and the image density has changed, process control which employs an optical sensor is performed.

First, correction of the optical sensor is carried out with transfer belt material as a substitute for a reference plate. More specifically, a current (If) flowing to a light-emitting diode LED of an optical sensor 12 in FIG. 1 is adjusted so that a value Vref obtained by converting an amount of light received by a light-receiving element for measuring an amount of light which is reflected by an intermediate transfer belt 7 in FIG. 1 into a voltage becomes a reference value Vba.

Thereafter, an engine controller performs control in advance to form a beta patch image of each color, change the development bias, read the toner amount in this case by means of the optical sensor, and set a suitable development bias by means of a lookup table which shows the value Vref read by the sensor and the correlation between the output result of the optical sensor and individual scatter correction values.

The engine controller also performs control in advance to form a half patch image of each color, change the laser power, read the toner amount in this case by means of the optical sensor, and set suitable laser power by means of a lookup table which shows the value Vref read by the sensor and the correlation between the output result of the optical sensor and individual scatter correction values.

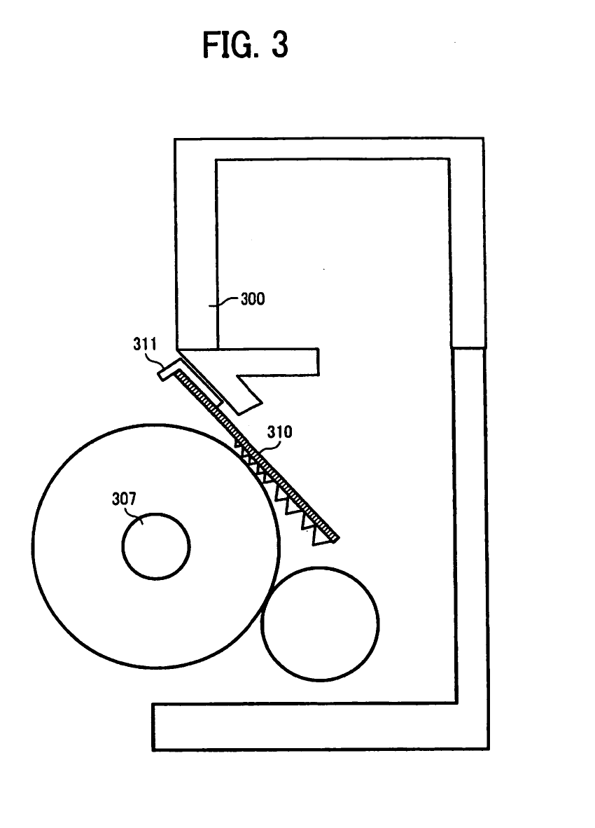

Part of a process cartridge is shown in FIG. 3 as one modification of the present invention. A layer thickness regulating member 310 which is shown in FIG. 3 is installed so as to abut against the development roller 307 stably with a pressure of 55 N/m. A SUS thin plate was used as the layer thickness regulating member 310. The layer thickness regulating member 310 is constituted such that its surface abuts against the development roller 307 and so that the free end of the layer thickness regulating member 310 protrudes upstream from the abutment section in the toner transportation direction. Furthermore, the layer thickness regulating member 310 is molded such that the surface roughness Ra of the abutment section thereof which abuts against the development roller 307 is 0.3 μm and formed so that the surface roughness Ra of the part which protrudes upstream from the abutment section in the toner transportation direction is 1.5 m. The surface roughness of the layer thickness regulating member 310 is molded by the blast-processed surface within the die and the nip width of the abutment section is 1.5 mm.

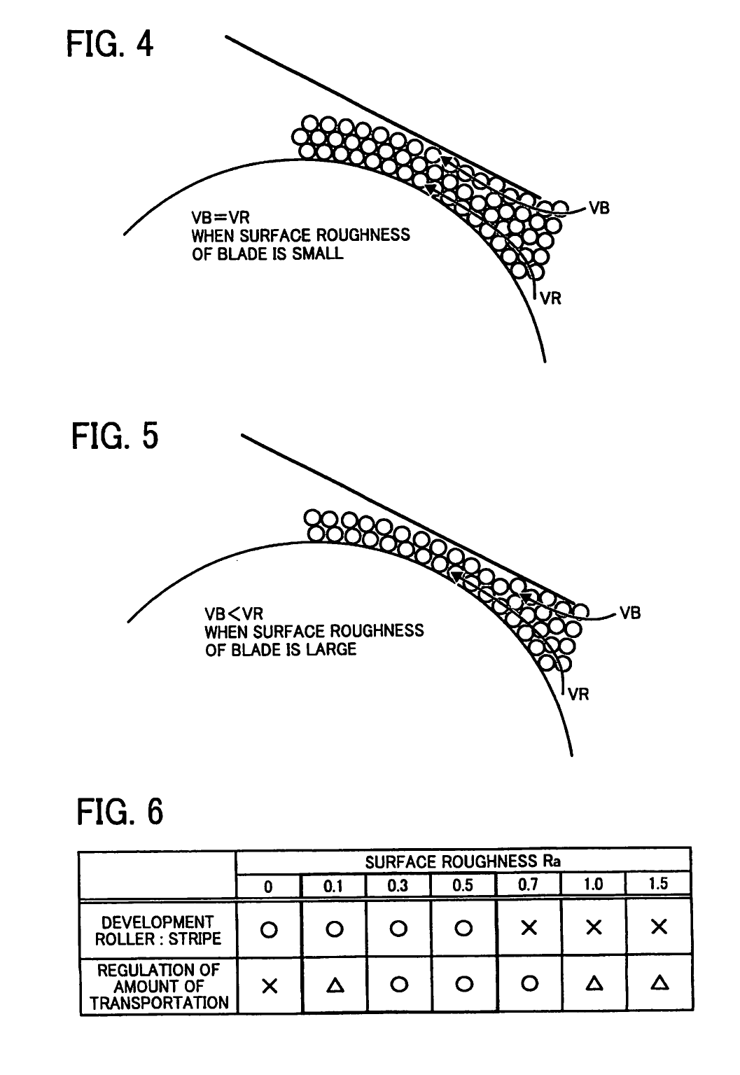

With such a constitution, when the roughness of the surface of a layer thickness regulating member 410 is reduced as much as possible like a mirror as shown in FIG. 4, the force for regulating the flow of toner is small at the surface of the layer thickness regulating member 410. That is, in order to regulate the amount of transportation by means of the abutment section, there is then a need to raise the line pressure of the abutment section through additional bending of the layer thickness regulating member 410 or by establishing abutment of the layer thickness regulating member 410 via its edge, and the like. However, raising the line pressure of the abutment section leads to a large amount of stress on the toner when the toner passes the abutment section, thereby promoting degradation of the toner due to breakdown thereof and the embedding and peeling of an external additive, which leads to degradation of the image quality. Therefore, roughening the surface of the layer thickness regulating member 510 as shown in FIG. 5 makes it possible to regulate the flow of toner at the surface of the layer thickness regulating member 510 and to reduce the amount of toner penetration in the vicinity of the abutment section. That is, the stress on the toner can be reduced by lowering the line pressure of the abutment section as much as possible and the amount of toner transportation can be regulated. However, when the roughness of the abutment section becomes too large, a development roller 507 opposite the abutment section is scraped in stripes over time and the image quality is degraded. That is, in order to obtain an appropriate amount of toner transportation and to maintain the quality of the development roller, affording the abutment section a surface roughness over a certain fixed area where this roughness is to be established may be considered. In FIGS. 4 and 5, the reference numeral VB represents the velocity of the flow of toner close to a blade and VR represents the velocity of the flow of toner close to the development roller.

Therefore, by conducting an experiment in which the surface roughness of the abutment section is varied as shown in FIG. 6, an area with which it is possible to achieve regulation of both scraping of the development roller and the amount of transportation was sought. As can be seen from the results of FIG. 6, it was possible to achieve both appropriate scraping of the development roller with an appropriate amount of toner transportation over time by making the surface roughness Ra of the abutment section 0.1 to 0.5 μm.

Thus, the layer thickness regulating member 310 was made to abut on its surface against the development roller 307 in order to reduce stress on the toner as much as possible as shown in FIG. 3. Further, by establishing a large degree of surface roughness for the part of the layer thickness regulating member 310 which protrudes from the abutment section, the amount of toner penetrating the abutment section was reduced and, by affording the abutment section a degree of roughness with which the development roller 307 is not scraped, it was possible to keep toner degradation over time to a minimum and suppress the amount of transportation to an appropriate amount over time.

### Second Embodiment

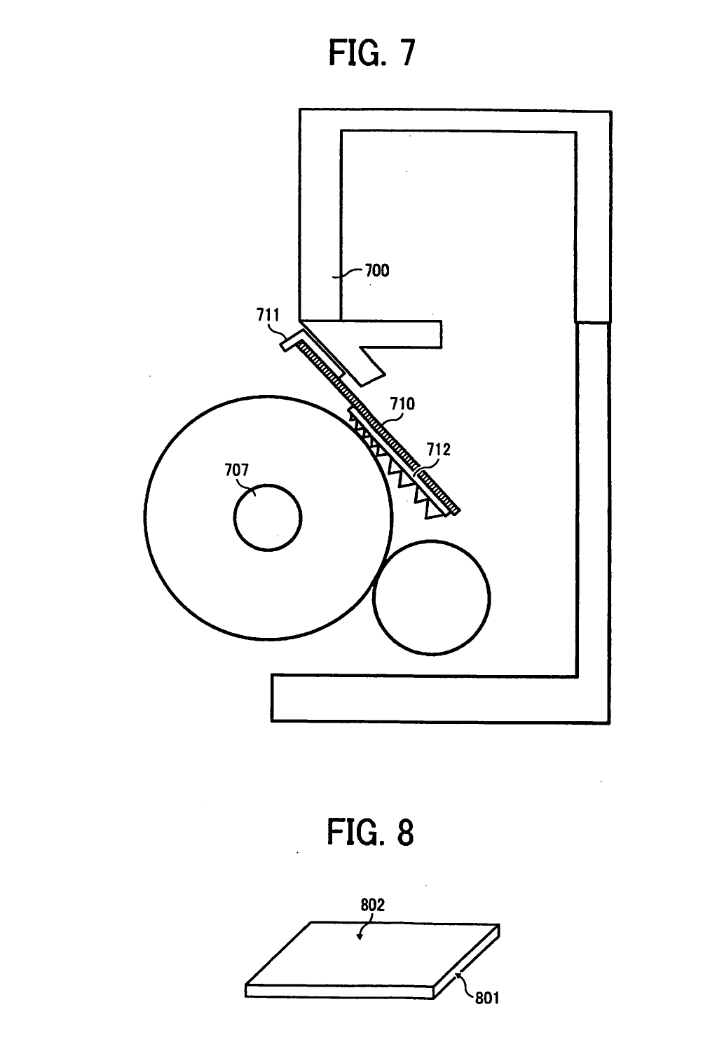

This embodiment employed a layer thickness regulating member 710 as shown in FIG. 7. The layer thickness regulating member 710 employs a SUS thin plate and is made by pasting sheet material 712 on the surface of the SUS thin plate. Thus, by pasting resin material on the thin plate, the frictional electrification properties of the toner and the transportation properties of the toner can be controlled. Furthermore, the sheet material 712 is constituted by a base layer 801 and a surface layer 802 as shown in FIG. 8. The base layer 801 uses a polycarbonate with good adhesion properties to urethane acrylate and has a thickness of 100 μm. The surface layer 802 employs urethane acrylate and has a thickness of 7 μm. This embodiment illustrates an example but a urethane-based or acrylic-based resin material can also be selected.

As illustrated hereinabove, the present invention is a process cartridge comprising a developer carrier which employs a nonmagnetic one-component developer and which is provided rotatably in the vicinity of or in contact with a latent image carrier; a developer supply member which is provided rotatably so as to supply powdered developer onto the developer carrier; and a layer thickness regulating member which reduces a layer thickness of the developer on the developer carrier by abutting against the developer carrier, wherein the layer thickness regulating member makes slide contact on its surface with the developer carrier and develops an electrostatic latent image on the latent image carrier by applying a predetermined voltage to the developer carrier, and the layer thickness regulating member has a roughness on a slide contact section thereof which makes slide contact with the developer carrier, and is configured so that the roughness of a part of the layer thickness regulating member which protrudes upstream in a developer transportation direction is greater than the roughness of the slide contact section. The present invention makes it possible to lower the line pressure of the abutment portion by causing the regulating member to abut on its surface against the development roller. However, lowering the line pressure means that the force for regulating the amount of toner transportation is small. Therefore, making the roughness of the part protruding from the abutment portion allows the flow of toner at the regulating blade surface to be suppressed and reduces the amount of penetration of toner into the abutment portion, and affording the abutment portion a small degree of roughness prevents scraping of the surface of the development roller and of the surface of the development blade.

By making the surface roughness Ra of the slide contact section of the layer thickness regulating member between 0.1 μm and 0.5 μm, the amount of toner transportation is regulated and scraping of the surface of the development roller and the surface of the regulating blade is prevented.

By molding the surface roughness of the layer thickness regulating member by means of an inner surface of a die which has been subjected to honing, blasting, or etching and by molding the roughness of the regulating blade surface by means of a die which has been subjected to honing, blasting or etching, it is possible to prevent warping and bending which is generated when blasting or etching the thin plate directly and to achieve a uniform roughness.

In addition, by making the layer thickness regulating member from metal material such as SUS, for example, low costs can be obtained for the regulating blade material.

Furthermore, by constituting the layer thickness regulating member by pasting a sheet member on a metal surface, the width of the slide contact section (nip) increases, thereby improving the toner charge properties and allowing the charge properties and transportation properties of the toner to be adjusted depending on the material of the sheet member. The sheet member can be constituted by forming a coating of urethane, acrylic, or urethane acrylate on a polycarbonate surface layer and can be made so that the coating is not scraped off even when worn due to sliding against the development roller.

Various modifications will become possible for those skilled in the art after receiving the teachings of the present disclosure without departing from the scope thereof.

1. A process cartridge, comprising:
a developer carrier which employs a nonmagnetic one-component developer and which is provided rotatably in the vicinity of or in contact with a latent image carrier;
a developer supply member which is provided rotatably so as to supply powdered developer onto the developer carrier; and
a layer thickness regulating member which reduces a layer thickness of the developer on the developer carrier by abutting against the developer carrier,
wherein the layer thickness regulating member makes slide contact on its surface with the developer carrier and develops an electrostatic latent image on the latent image carrier by applying a predetermined voltage to the developer carrier, and
the layer thickness regulating member has a roughness on a slide contact section thereof which makes slide contact with the developer carrier, and is configured so that the roughness of a part of the layer thickness regulating member which protrudes upstream in a developer transportation direction is greater than the roughness of the slide contact section.

2. The process cartridge according to claim 1, wherein the surface roughness Ra of the slide contact section of the layer thickness regulating member is between 0.1 μm and 0.5 μm.

3. The process cartridge according to claim 1, wherein the surface roughness of the layer thickness regulating member is molded by means of an inner surface of a die which has been subjected to honing, blasting, or etching.

4. The process cartridge according to claim 1, wherein the layer thickness regulating member is made of a metal material.

5. The process cartridge according to claim 4, wherein the metal material is SUS.

6. The process cartridge according to claim 1, wherein the layer thickness regulating member is formed by pasting a sheet member on a metal surface.

7. The process cartridge according to claim 6, wherein the sheet member is made by coating a polycarbonate surface layer with urethane, acrylic or urethane acrylic.

8. A development device having a process cartridge, the process cartridge comprising:
a developer carrier which employs a nonmagnetic one-component developer and which is provided rotatably in the vicinity of or in contact with a latent image carrier;
a developer supply member which is provided rotatably so as to supply powdered developer onto the developer carrier; and
a layer thickness regulating member which reduces a layer thickness of the developer on the developer carrier by abutting against the developer carrier,
wherein the layer thickness regulating member makes slide contact on its surface with the developer carrier and develops an electrostatic latent image on the latent image carrier by applying a predetermined voltage to the developer carrier, and
the layer thickness regulating member has a roughness on a slide contact section thereof which makes slide contact with the developer carrier, and is configured so that the roughness of a part of the layer thickness regulating member which protrudes upstream in a developer transportation direction is greater than the roughness of the slide contact section.

9. An image formation apparatus which uses a development device having a process cartridge, the process cartridge comprising:
a developer carrier which employs a nonmagnetic one-component developer and which is provided rotatably in the vicinity of or in contact with a latent image carrier;
a developer supply member which is provided rotatably so as to supply powdered developer onto the developer carrier; and
a layer thickness regulating member which reduces a layer thickness of the developer on the developer carrier by abutting against the developer carrier,
wherein the layer thickness regulating member makes slide contact on its surface with the developer carrier and develops an electrostatic latent image on the latent image carrier by applying a predetermined voltage to the developer carrier, and
the layer thickness regulating member has a roughness on a slide contact section thereof which makes slide contact with the developer carrier, and is configured so that the roughness of a part of the layer thickness regulating member which protrudes upstream in a developer transportation direction is greater than the roughness of the slide contact section.
